(19) United States
(12) Patent Application Publication
(10) Pub. No.: US 2010/0259519 A1
(43) Pub. Date: Oct. 14, 2010

(54) SUBPIXEL STRUCTURE AND LIQUID CRYSTAL DISPLAY PANEL

(75) Inventors: CHIEN-CHENG CHEN, Miao-Li County (TW); YU-CHENG LIN, Miao-Li County (TW); WEN-MING HUNG, Miao-Li County (TW); YUNG-HSUN WU, Miao-Li County (TW); CHUEH-JU CHEN, Miao-Li County (TW)

Correspondence Address: Altis Law Group, Inc.;ATTN: Steven Reiss, 288 SOUTH MAYO AVENUE, CITY OF INDUSTRY, CA, 91789, US

(73) Assignee: INNOLUX DISPLAY CORP., Miao-Li County (TW)

(21) Appl. No.: 12/721,509

(22) Filed: Mar. 10, 2010

(30) Foreign Application Priority Data
Apr. 14, 2009 (CN) 200910301554.4

(51) Int. Cl. G02F 1/1368; G06F 3/038; G09G 3/36

(52) U.S. Cl. 345/206; 345/213; 345/90; 349/48

(57) ABSTRACT

A subpixel structure of a liquid crystal display is disclosed. The subpixel structure is disposed between a first substrate and a second substrate, in which the subpixel structure includes a first portion and a second portion. The subpixel structure further includes: a data line, a first scan line and a second scan line intersecting the data line; a first transistor disposed on the first scan line and connected to the first portion of the subpixel structure; a second transistor disposed on the first scan line and connected to the second portion of the subpixel structure; and a third transistor disposed on the second scan line and connected to the second portion of the subpixel structure.

### BACKGROUND

1. Technical Field

The disclosure relates to a subpixel structure of a liquid crystal display, and more particularly, to a subpixel structure capable of improving the charging ability of capacitors.

2. Description of Related Art

Thin film transistor liquid crystal displays (TFT-LCDs) primarily utilize thin film transistors arranged in the form of a matrix and electronic devices such as capacitors and conversion pads to drive liquid crystal pixels for generating vivid color pictures. Since TFT-LCDs have the advantage of portability, low power consumption, and low radiation, they have been widely used in various portable electronic products, such as notebook computers and personal digital assistants (PDAs). The TFT-LCDs are also gradually replacing the cathode ray tube (CRT) monitors used with conventional desktop computers.

A conventional TFT-LCD is composed of a thin film transistor array substrate, a color filter array substrate, and a liquid crystal layer disposed between the thin film transistor array substrate and the color filter array substrate. The thin film transistor array substrate is composed of thin film transistors arranged in the manner of an array and a plurality of pixel electrodes disposed with respect to the thin film transistors. The color filter array substrate is composed of a plurality of color filters arranged in the manner of an array, which preferably provides vivid colorings for each pixel of the liquid crystal display. A pixel structure is composed of a pixel electrode and a corresponding thin film transistor, in which the thin film transistor is used as a switch element for the pixel structure. In order to control the gray level of each individual pixel, pixels are selected through a plurality of intersecting scan lines and data lines and voltages are provided to display data corresponding to each pixel. Moreover, a portion of the pixel electrode is often disposed on the scan line or common line to form storage capacitors.

A pixel is typically composed of three subpixels and the subpixels are fabricated with corresponding color filters to show different colors such as red, green, or blue. A subpixel structure could also be further divided into two portions to provide better graphical effects and refreshing rate for gray level conversion of the liquid crystal display. Under this architecture, different portions of each subpixel are controlled individually by a scan line and a thin film transistor. In order to improve phenomenon such as color washout, different voltages are applied to different portions of each subpixel respectively to generate more direction for the liquid crystals.

However, in order to provide different voltages to the two different portions of a subpixel, the turn-on time of each scan line is reduced substantially under a 60 Hz refresh rate. For instance, the turn-on time of a display with 1024×768 resolution is reduced significantly from 16.66 ms to 8.33 ms. If a higher refresh rate (such as 120 Hz) is used to drive the subpixel, the turn-on time for each scan line is reduced even further to 4.16 ms. As the turn-on time of each scan line under such high frequency is reduced significantly, the charging ability of the storage capacitor connected to the scan line within the pixel structure also becomes insufficient.

### SUMMARY

According to an embodiment of the present disclosure, a subpixel structure of a liquid crystal display is disclosed. The subpixel structure is disposed between a first substrate and a second substrate, in which the subpixel structure includes a first portion and a second portion. The subpixel structure further includes: a data line, a first scan line and a second scan line intersecting the data line; a first transistor disposed on the first scan line and connected to the first portion of the subpixel structure; a second transistor disposed on the first scan line and connected to the second portion of the subpixel structure; and a third transistor disposed on the second scan line and connected to the second portion of the subpixel structure.

According to another embodiment of the present disclosure, a method for driving a liquid crystal display panel is disclosed. The method includes the steps of: providing a subpixel structure having a first portion and a second portion, a data line, a first scan line and a second scan line intersecting the data line; inputting a first voltage from the data line at a first time period for charging the first portion of the subpixel structure and pre-charging the second portion of the subpixel structure simultaneously; and inputting a second voltage from the data line at a second time period for only charging the second portion of the subpixel structure.

According to another embodiment of the present disclosure, a liquid crystal display panel is disclosed. The liquid crystal display panel includes a first substrate, a second substrate, at least a subpixel structure disposed between the first substrate and the second substrate, and a liquid crystal layer disposed between the first substrate and the subpixel structure, in which the subpixel structure includes a first portion and a second portion. The subpixel structure further includes: a data line, a first scan line and a second scan line intersecting the data line; a first transistor disposed on the first scan line and connected to the first portion of the subpixel structure; a second transistor disposed on the first scan line and connected to the second portion of the subpixel structure; and a third transistor disposed on the second scan line and connected to the second portion of the subpixel structure.

According to another embodiment of the present disclosure, an electronic device is disclosed. The electronic device includes the above liquid crystal display panel and a controller. The controller is electrically connected to the liquid crystal display panel and provides image data to the liquid crystal display panel.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an equivalent circuit diagram of a subpixel structure having three thin film transistors according to a first embodiment of the present disclosure.

FIG. 2 illustrates a schematic diagram of the subpixel structure shown in FIG. 1.

FIG. 3 illustrates a gray level and timing diagram of driving a pixel structure under 120 Hz frequency according to the first embodiment of the present disclosure.

FIG. 4 illustrates an equivalent circuit diagram of a subpixel structure having four thin film transistors according to an embodiment of the present disclosure.

FIG. 5 illustrates a schematic diagram of the subpixel structure shown in FIG. 4.

FIG. 6 is an actual view of the subpixel structure shown in FIG. 4.

FIG. 7 illustrates a gray level and timing diagram of driving a pixel structure under 120 Hz frequency according to a second embodiment of the present disclosure.

FIG. 8A illustrates a schematic diagram of an electronic device.

FIG. 8B illustrates a schematic diagram of a liquid crystal display panel including the subpixel structure of FIG. 1.

### DETAILED DESCRIPTION

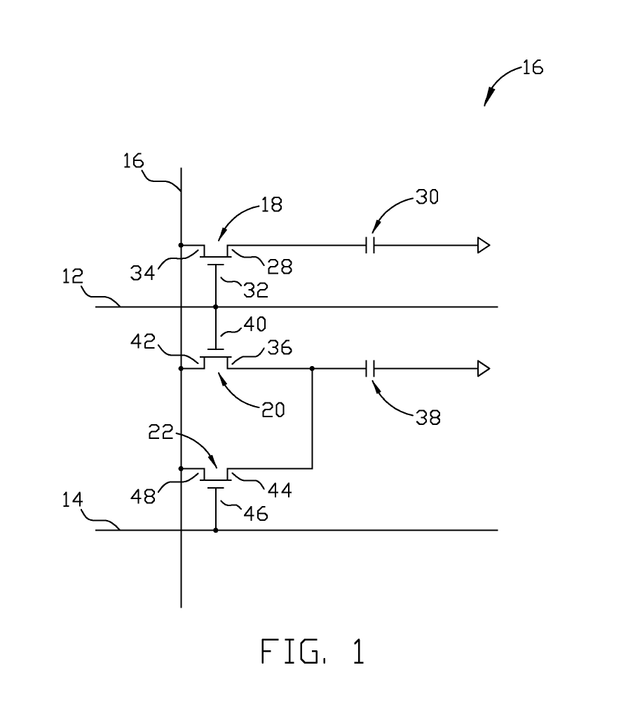

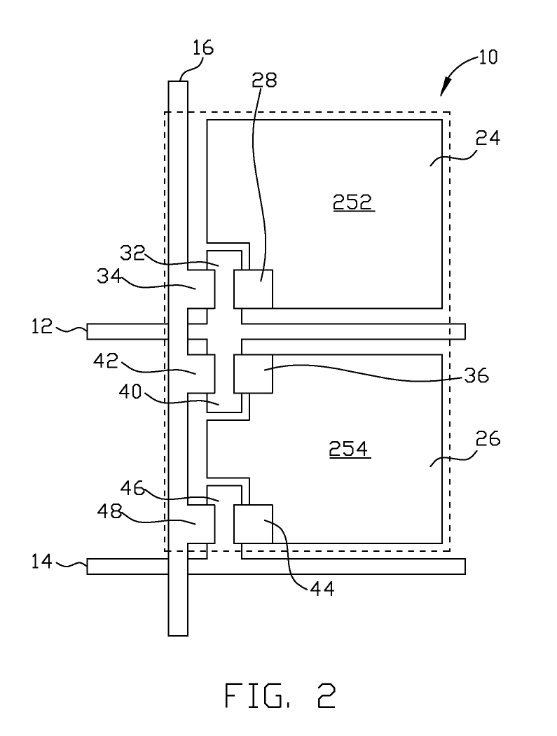

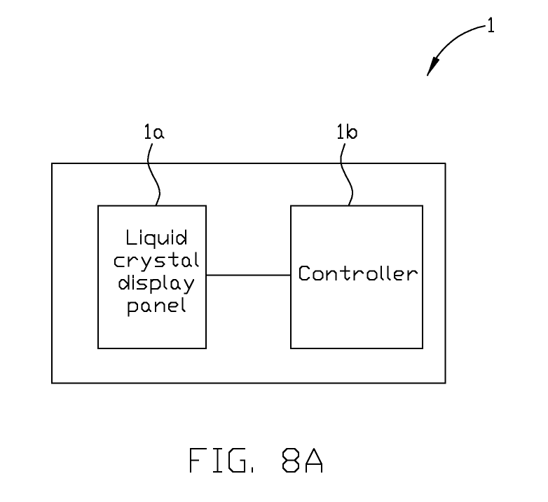

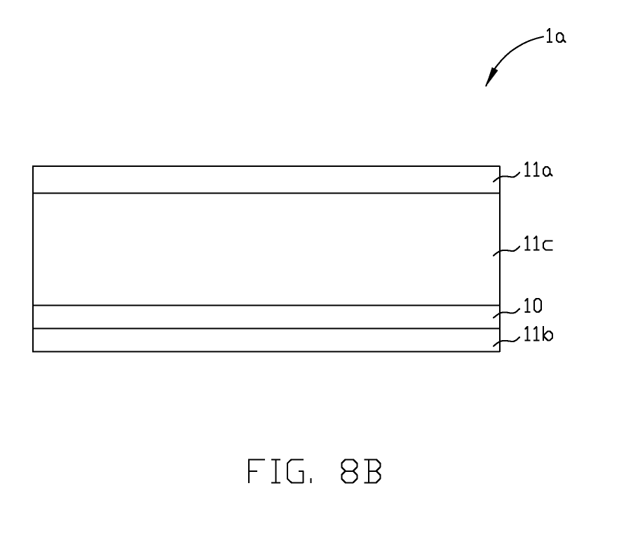

Referring to FIGS. 1, 2, 8A, and 8B, FIG. 1 illustrates an equivalent circuit diagram of a subpixel structure having three thin film transistors according to a first embodiment of the present disclosure, FIG. 2 illustrates a schematic diagram of the subpixel structure from FIG. 1, FIG. 8A illustrates a schematic diagram of an electronic device, and FIG. 8B illustrates a schematic diagram of a liquid crystal display panel including the subpixel structure of FIG. 1. As shown in the figures, the electronic device 1 includes a liquid crystal display panel 1a and a controller 1b electrically connected to the liquid crystal display panel 1a for providing image data to the liquid crystal display panel 1a. The electronic device 1 can be, for example, a computer, a notebook computer, a mobile telephone, a portable electronic game, or a television. The liquid crystal display panel 1a of the embodiment of the present disclosure includes a first substrate 11a, a second substrate 11b, a subpixel structure 10, and a liquid crystal layer 11c disposed between the first substrate 11a and the subpixel structure 10. The subpixel structure 10 of the liquid crystal display of the first embodiment of the present disclosure is disposed between the first substrate 11a and the second substrate 11b, such as between a color filter array substrate and a thin film transistor array substrate. Each subpixel structure 10 includes two horizontal scan lines 12 and 14 disposed in parallel, a vertical data line 16 intersecting both the scan lines 12 and 14, and three thin film transistors 18, 20, and 22. Both the film transistors 18 and 20 are electrically connected to the scan lines 12 and the data line 16. The thin film transistor 22 is electrically connected to the scan lines 14 and the data line 16. The thin film transistors 18, 20, and 22 can be either bottom gate thin film transistors or top gate thin film transistors. Each of the subpixel structure 10 includes two portions, including a first portion 24 and a second portion 26. In this embodiment, the thin film transistor 18 is disposed on the scan line 12 for controlling the pixel electrode 252 within the first portion 24 of the subpixel structure 10, the thin film transistor 20 is disposed on the scan line 12 for controlling the pixel electrode 254 within the second portion 26 of the subpixel structure 10, and the thin film transistor 22 is disposed on the scan line 14 for controlling the pixel electrode 254 within the second portion 26 of the subpixel structure 10.

As shown in FIG. 1, a drain 28 of the thin film transistor 18 is electrically connected to a capacitor 30 within the first portion 24 of the subpixel structure 10, a gate 32 is connected to the scan line 12, and a source 34 is connected to the data line 16. A drain 36 of the thin film transistor 20 is connected to a capacitor 38 within the second portion 26 of the subpixel structure 10, a gate 40 is connected to the scan line 12, and a source 42 is connected to the data line 16. A drain 44 of the thin film transistor 22 is connected to the capacitor 38 of the second portion 26 of the subpixel structure 10, a gate 46 is connected to the scan line 14, and a source 48 is connected to the data line 16. In this embodiment, the capacitors 30 and 38 disposed in the subpixel structure 10 can include storage capacitors and liquid crystal capacitors, but not limited thereto.

As the subpixel structure 10 is being charged, the thin film transistors 18 and 20 are turned on by turning on the scan line 12 to charge the first portion 24 and second portion 26 of the subpixel structure 10 simultaneously. Next, the scan line 12 is turned off and the thin film transistor 22 is turned on by turning on the scan line 14 to charge the second portion 26 of the subpixel structure 10 once again. By using this method to charge the subpixels, different voltages can be input into the subpixel under different gray level, thereby achieving a voltage division effect. In other words, by providing a structure with three thin film transistors 18, 20, and 22, two scan lines 12 and 14, and a data line 16, the charging time for the subpixel is increased substantially and a pre-charge is achieved accordingly.

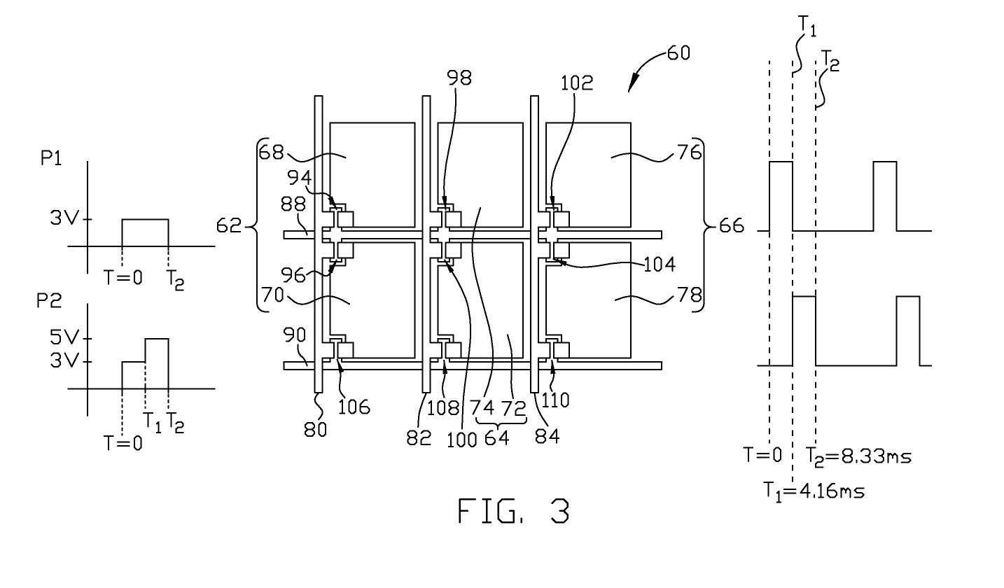

Referring to FIG. 3, FIG. 3 illustrates a gray level and timing diagram of driving a pixel structure 60 under 120 Hz frequency according to the first embodiment of the present disclosure. As shown in FIG. 3, each pixel structure 60 of the thin film transistor liquid crystal display is primarily composed of three subpixels, such as a red subpixel 62, a green subpixel 64 and a blue subpixel 66. However, each pixel structure can also be composed of more than three subpixels, which is also within the scope of the present disclosure. Each subpixel is further divided into two portions. For instance, the red subpixel 62 is divided into a first portion 68 and a second portion 70, the green subpixel 64 is divided into a first portion 72 and a second portion 74, and the blue subpixel 66 is divided into a first portion 76 and a second portion 78. The pixel structure 60 of this embodiment can include three data lines 80, 80, and 84 and two scan lines 88 and 90 intersecting the data lines 80, 82, and 84.

Six thin film transistors 94, 96, 98, 100, 102, and 104 can be disposed on the scan line 88 to control a portion of each subpixel. For instance, the scan line 88, the thin film transistors 94 and 96, and the data line 80 together control the first portion 68 and second portion 70 of the red subpixel 62, the scan line 88, the thin film transistors 98 and 100, and the data line 82 together control the first portion 72 and second portion 74 of the green subpixel 64, and the scan line 88, the thin film transistors 102 and 104, and the data line 84 together control the first portion 76 and second portion 78 of the blue subpixel 66. Similarly, three thin film transistors 106, 108, and 110 are disposed on the scan line 90, in which the scan line 90, the thin film transistor 106, and the data line 80 together control the second portion 70 of the red subpixel 62, the scan line 90, the thin film transistor 108, and the data line 82 together control the second portion 74 of the green subpixel 64, and the scan line 90, the thin film transistor 110, and the data line 84 together control the second portion 78 of the blue subpixel 66.

A relational diagram between the pixel electrode and gray level voltage received is illustrated on the left side of the pixel structure 60, in which P1 represents the gray level voltage received by the pixel electrode of the first portion 68 of the red subpixel 62 during the time period T=0 to T2, and P2 represents the gray level voltage received by the pixel electrode of the second portion 70 of the red subpixel 62 during the time period T=0 to T2.

For easy understanding, only one subpixel will be explained by the timing diagram on the right side of FIG. 3. For example, the charging and timing diagram of the first portion 68 and the second portion 70 for only the red subpixel 62 will now be explained. At T=0, as no voltage is input into the scan lines 88 and 90 and the gates of the thin film transistors 94, 96, and 106 are closed, the first portion 68 and second portion 70 of the subpixel 62 both represent a dark state. After the gates of the thin film transistors 94 and 96 are opened by turning on the scan line 88, a first voltage (such as a 3V voltage) is input from the data line 80 to the source of the thin film transistors 94 and 96 for charging the first portion 68 of the red subpixel 62 and pre-charging the second portion 70 of the red subpixel 62 simultaneously. Accordingly, the gray level voltage is received by the pixel electrode of the first portion 68 and the second portion 70 at T1, such as 4.16 ms. Next, the scan line 88 is turned off and the scan line 90 is turned on, and a second voltage (such as a 5V voltage) is input from the data line 80, 82, and 84 to the source of the thin film transistor 106 for charging the second portion 70 at T2, such as the 4.16 ms interval between the 4.16 ms to 8.33 ms. Since the thin film transistors 94 and 96 are turned off at this moment, the gray level received by the pixel electrode of the first portion 68 is maintained at 3V while the gray level received by the pixel electrode of the second portion 70 is at 5V.

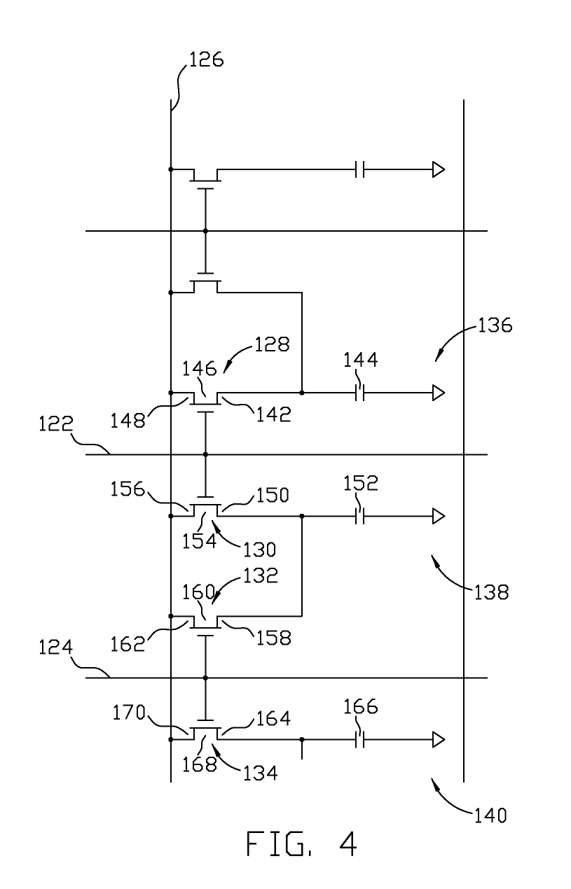

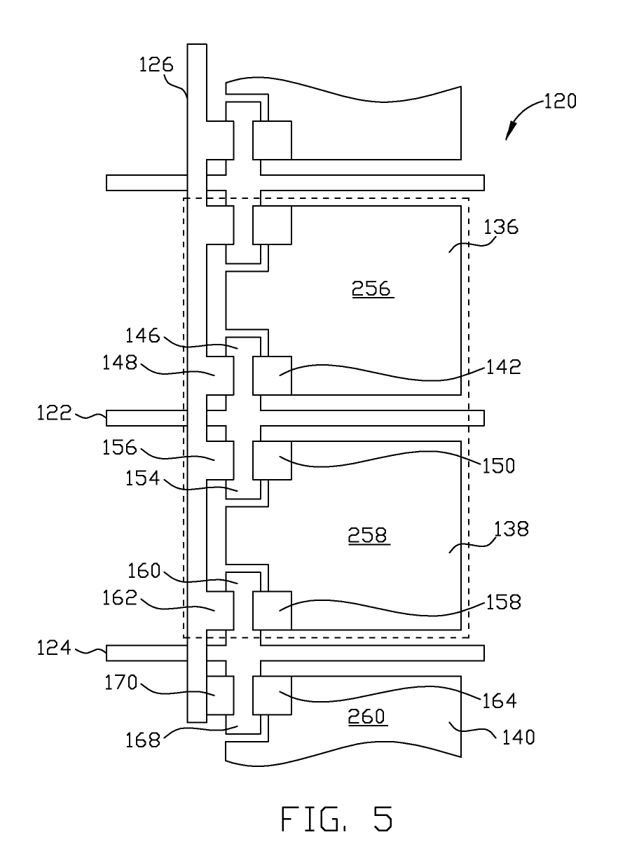

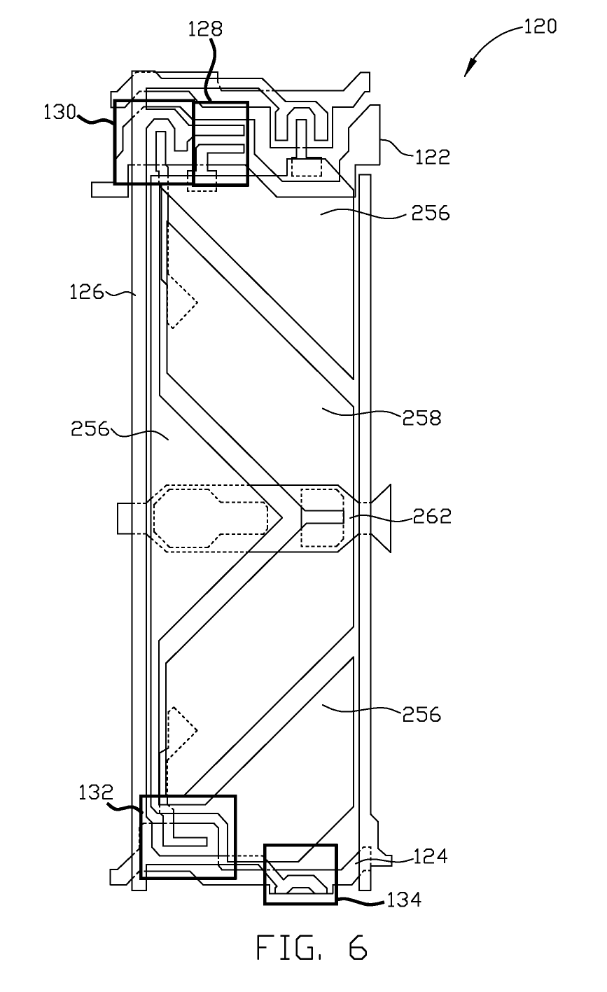

Referring to FIGS. 4-6, FIG. 4 illustrates an equivalent circuit diagram of a subpixel structure having four thin film transistors according to an embodiment of the present disclosure, FIG. 5 illustrates a schematic diagram of the subpixel structure from FIG. 4, and FIG. 6 is an actual view of the subpixel structure of this embodiment. As shown in FIGS. 5-6, the subpixel structure 120 of this embodiment includes two horizontal scan lines 122 and 124, a vertical data line 126 intersecting the scan lines 122 and 124, a common electrode 262, and four thin film transistors 128, 130, 132, and 134 electrically connected to the data line 126 respectively. Both thin film transistor 128 and 130 are electrically connected to the scan line 122 and both the thin film transistor 132 and 134 are electrically connected to the scan line 124. Similar to the aforementioned embodiment, each subpixel structure 120 primarily includes two portions, including a first portion 136 containing pixel electrode 256 and a second portion 138 containing a substantially v-shaped pixel electrode 258. In this embodiment, the thin film transistor 128 is disposed on the scan line 122 and connected to the pixel electrode 256 of the first portion 136 of the subpixel structure 120, the thin film transistor 130 is disposed on the scan line 122 and connected to the pixel electrode 258 of the second portion 138 of the subpixel structure 120 and the thin transistor 132 is disposed on the scan line 124 and connected to the pixel electrode 258 of the second portion 138 of the subpixel structure 120. Another subpixel structure adjacent to the subpixel structure 120 includes a third portion 140 containing a pixel electrode 260 and the thin film transistor 134 is disposed on the scan line 124 and connected to the pixel electrode 260 of the third portion 140.

As shown in FIG. 4, a drain 142 of the thin film transistor 128 is electrically connected to a capacitor 144 within the first portion 136 of the subpixel structure 120, a gate 146 is connected to the scan line 122, and a source 148 is connected to the data line 126. A drain 150 of the thin film transistor 130 is connected to a capacitor 152 within the second portion 138 of the subpixel structure 120, a gate 154 is connected to the scan line 122, and a source 156 is connected to the data line 126. A drain 158 of the thin film transistor 132 is connected to a capacitor 152 within the second portion 138 of the subpixel structure 120, a gate 160 is connected to the scan line 124, and a source 162 is connected to the data line 126. A drain 164 of the thin film transistor 134 is connected to a capacitor 166 within the third portion 140 adjacent to the subpixel structure 120, a gate 168 is connected to the scan line 124, and a source 170 is connected to the data line 126. In this embodiment, the capacitors 144, 152, and 166 disposed in the subpixel structure 120 could include storage capacitors and liquid crystal capacitors, but not limited thereto.

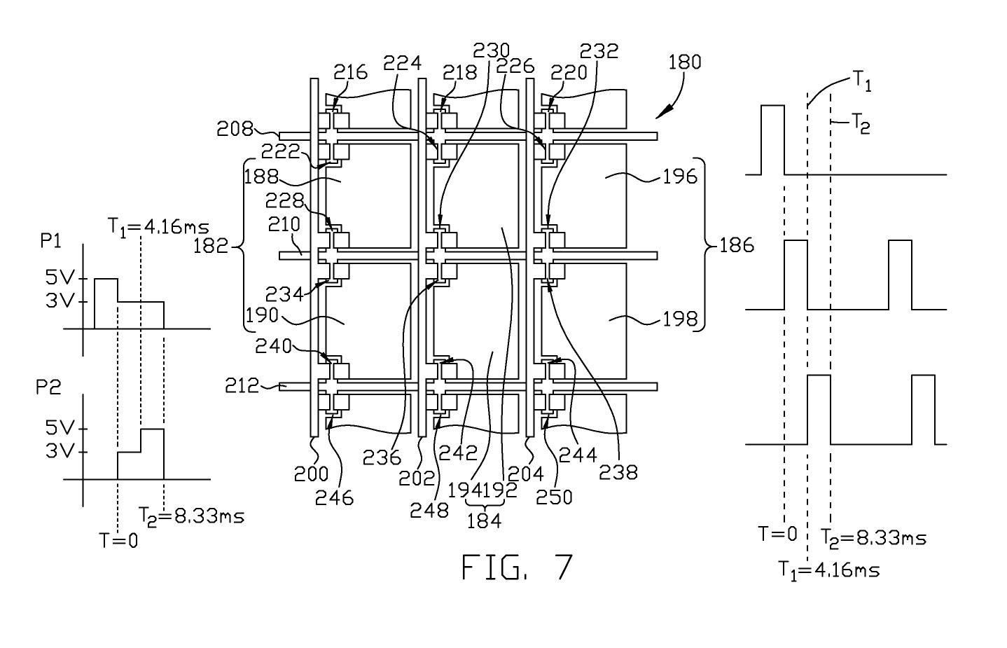

Referring to FIG. 7, FIG. 7 illustrates a gray level and timing diagram of driving a pixel structure under 120 Hz frequency according to a second embodiment of the present disclosure. As shown in FIG. 7, each pixel structure 180 of the thin film transistor liquid crystal display is primarily composed of three subpixels, such as a red subpixel 182, a green subpixel 184, and a blue subpixel 186. However, each pixel structure could also be composed of more than three subpixels, which is also within the scope of the present disclosure. Each subpixel is further divided into two portions. For instance, the red subpixel 182 is divided into a first portion 188 and a second portion 190, the green subpixel 184 is divided into a first portion 192 and a second portion 194, and the blue subpixel 186 is divided into a first portion 196 and a second portion 198. The pixel structure 180 of this embodiment also includes three data lines 200, 202, and 204 and three scan lines 208, 210, and 212 intersecting the data lines 200, 202, and 204.

Six thin film transistors can be disposed on each of the scan lines 208, 210, and 212 corresponding to each portion of the subpixel. For instance, thin film transistors 216, 218, 220, 222, 224, and 226 are disposed on the scan line 208, in which the thin film transistors 216, 218, and 220 are used to control the second portions of the red, green, and blue subpixel structures of the previous pixel structure, and the thin film transistors 222, 224, and 226 are used to control the first portions 188, 192, and 196 of the red, green, and blue subpixel structures 182, 184, and 186 of the pixel structure 180. Thin film transistors 228, 230, 232, 234, 236, and 238 are disposed on the scan line 210, in which the thin film transistors 228, 230, and 232 are used to control the first portions 188, 192, and 196 of the red, green, and blue subpixel structures 182, 184, and 186 of the pixel structure 180, and the thin film transistors 234, 236, and 238 are used to control the second portions 190, 194, and 198 of the red, green, blue subpixel structures 182, 184, and 186 of the pixel structure 180. Thin film transistors 240, 242, 244, 246, 248, and 250 are disposed on the scan line 212, in which the thin film transistors 240, 242, and 244 are used to control the second portions 190, 194, and 198 of the red, green, and blue subpixel structures 182, 184, and 186 of the pixel structure 180, and the thin film transistors 246, 248, and 250 are used to control the first portions of the red, green, and blue subpixel structures of the next pixel structure.

A relational diagram between the pixel electrode and gray level voltage received is illustrated on the left side of the pixel structure 180, in which P1 represents the gray level voltage received by the pixel electrode of the first portion 188 of the red subpixel 182 during the time period t=0 to t2, and P2 represents the gray level voltage received by the pixel electrode of the second portion 190 of the red subpixel 182 during the time period t=0 to t2. An explanation is provided with the timing diagram on the right side of the pixel structure 180 regarding a means of driving one subpixel, such as the charging of the first portion 188 and the second portion 190 of the red subpixel 182. At a previous frame of t=0, the gates of the thin film transistors 216 and 222 are opened through the scan lines and a voltage (such as 5V) is provided through the data line 200 to the sources of the thin film transistors 216 and 222, which preferably charges the second portion (not shown) controlled by the thin film transistor 216 and within the red subpixel of the previous pixel and pre-charges the first portion 188 of the red subpixel 182 simultaneously. The pixel electrode of the first portion 188 of the red subpixel 182 at the time period prior to t=0 would then receives a 5V gray level voltage accordingly. Next, the scan line 208 is turned off and the scan line 210 is turned on, and a 3V voltage is input from the data line 200 to the sources of the thin film transistors 228 and 234 to charge the first portion 188 and second portion 190 of the red subpixel 182 simultaneously. The pixel electrodes of the first portion 188 and second portion 190 of the red subpixel 182 then receive a gray level voltage of 3V between the time period t=0 to t1. Next, the scan line 210 is turned off and the scan line 212 is turned on, and a 5V voltage is input from the data line 200 to the sources of the thin film transistors 240 and 246 and charges the second portion 190 and first portion (not shown) within the red subpixel of the next pixel structure. As the thin film transistors 228 and 236 are turned off at this point, the gray level voltage received by the pixel electrode of the first portion 188 in the time period between t1 and t2 is maintained at 3V while the gray level voltage received by the pixel electrode of the second portion 190 is at 5V.

In the above-mentioned embodiments of the present disclosure, three or four thin film transistors are disposed in a subpixel structure to improve the charging time and overall charging ability for each portion of the subpixel structure as the subpixel structure is driven under a 120 Hz frequency. According to the architecture about three thin film transistors, two of the thin film transistors are disposed on the first scan line of the subpixel structure for controlling the first portion and second portion of the subpixel structure respectively while the other thin film transistor is disposed on the second scan line for controlling the second portion of the subpixel structure. This resolves the issue of insufficient charging ability resulted from reduction of turn-on time for the first portion and second portion of each subpixel structure. In the architecture about four thin film transistors, two of the four thin film transistors are disposed on one scan line and another two of the four thin film transistors are disposed on another scan line. This design not only provides sufficient charging ability to two portions of the subpixel structure, but also pre-charges the next subpixel. As of the aforementioned structures all allow two portions of the subpixel to be charged simultaneously by turning on one of the scan lines. Some embodiments of the present disclosure maintain the charging ability of each portion of the subpixel as different voltages are supplied to each portion of the subpixel and thereby resolves the issue of color washout. Lastly, the pixel structure of some embodiments can be applied to various thin film transistor liquid crystal displays, such as twisted nematic type (including TN, STN, and DSTN) displays, in-plane switching (including AS-IPS, DD-IPS) displays, and vertically aligned (including PVA, S-PVA, MVA, P-MVA) displays, which are all within the scope of the present disclosure.

Those skilled in the art will readily observe that numerous modifications and alterations of the device and method may be made while retaining the teachings of the disclosure.

What is claimed is:

1. A subpixel structure of a liquid crystal display, disposed between a first substrate and a second substrate, wherein the subpixel structure comprises a first portion and a second portion, the subpixel structure further comprising:
a data line;
a first scan line intersecting the data line;
a second scan line intersecting the data line;
a first transistor disposed on the first scan line and connected to the first portion of the subpixel structure;
a second transistor disposed on the first scan line and connected to the second portion of the subpixel structure; and
a third transistor disposed on the second scan line and connected to the second portion of the subpixel structure.

2. The subpixel structure of claim 1, wherein the subpixel structure comprises a red subpixel, a green subpixel, or a blue subpixel.

3. The subpixel structure of claim 1, further comprising at least one capacitor disposed in the first portion of the subpixel structure and connected to the first transistor.

4. The subpixel structure of claim 1, further comprising at least one capacitor disposed in the second portion of the subpixel structure and connected to the second transistor and the third transistor.

5. The subpixel structure of claim 1, further comprising a fourth transistor disposed on the second scan line.

6. The subpixel structure of claim 5, wherein the fourth transistor is connected to a third portion of another subpixel structure adjacent to the subpixel structure.

7. The subpixel structure of claim 5, wherein each of the first transistor, the second transistor, the third transistor, and the fourth transistor is a thin film transistor.

8. The subpixel structure of claim 1, wherein the first substrate comprises a color filter array substrate.

9. The subpixel structure of claim 1, wherein the second substrate comprises a thin film transistor array substrate.

10. The subpixel structure of claim 1, further comprising at least one pixel electrode disposed in the first portion of the subpixel structure and connected to the first transistor.

11. The subpixel structure of claim 1, further comprising at least one pixel electrode disposed in the second portion of the subpixel structure and connected to the second transistor and the third transistor.

12. The subpixel structure of claim 1, each of the first transistor, the second transistor, and the third transistor is connected to the data line.

13. A method for driving a liquid crystal display panel, comprising:
providing a subpixel structure having a first portion and a second portion, a data line, and a first scan line and a second scan line intersecting the data line;
inputting a first voltage from the data line at a first time period for charging the first portion of the subpixel structure and pre-charging the second portion of the subpixel structure simultaneously; and
inputting a second voltage from the data line at a second time period for only charging the second portion of the subpixel structure.

14. The method of claim 13, wherein the first voltage is different from the second voltage.

15. The method of claim 13, further comprising disposing a first transistor and a second transistor on the first scan line and connecting the first transistor and the second transistor to the first portion of the subpixel structure, and disposing a third transistor on the second scan line and connecting the third transistor to the second portion of the subpixel structure.

16. The method of claim 15, further comprising disposing a fourth transistor on the second scan line and connecting the fourth transistor to a third portion of another subpixel structure adjacent to the subpixel structure.

17. A liquid crystal display panel, comprising:
a first substrate and a second substrate;
at least a subpixel structure disposed between the first substrate and the second substrate, wherein the subpixel structure comprises a first portion and a second portion, the subpixel structure further comprising:
a data line;
a first scan line intersecting the data line;
a second scan line intersecting the data line;
a first transistor disposed on the first scan line and connected to the first portion of the subpixel structure;
a second transistor disposed on the first scan line and connected to the second portion of the subpixel structure; and
a third transistor disposed on the second scan line and connected to the second portion of the subpixel structure; and
a liquid crystal layer disposed between the first substrate and the subpixel structure.

18. The liquid crystal display panel of claim 17, wherein the subpixel structure comprises a red subpixel, a green subpixel, or a blue subpixel.

19. The liquid crystal display panel of claim 17, further comprising at least one capacitor disposed in the first portion of the subpixel structure and connected to the first transistor.

20. The liquid crystal display panel of claim 17, further comprising at least one capacitor disposed in the second portion of the subpixel structure and connected to the second transistor and the third transistor.

21. The liquid crystal display panel of claim 17, further comprising a fourth transistor disposed on the second scan line.

22. The liquid crystal display panel of claim 21, wherein the fourth transistor is connected to a third portion of another subpixel structure adjacent to the subpixel structure.

23. The liquid crystal display panel of claim 21, wherein each of the first transistor, the second transistor, the third transistor, and the fourth transistor is a thin film transistor.

24. The liquid crystal display panel of claim 17, wherein the first substrate comprises a color filter array substrate.

25. The liquid crystal display panel of claim 17, wherein the second substrate comprises a thin film transistor array substrate.

26. The liquid crystal display panel of claim 17, further comprising at least one pixel electrode disposed in the first portion of the subpixel structure and connected to the first transistor.

27. The liquid crystal display panel of claim 17, further comprising at least one pixel electrode disposed in the second portion of the subpixel structure and connected to the second transistor and the third transistor.

28. An electronic device, comprising:
the liquid crystal display panel of claim 17; and
a controller electrically connected to the liquid crystal display panel and providing image data to the liquid crystal display panel.
